(19) United States
(12) Patent Application Publication
(10) Pub. No.: US 2010/0027211 A1
(43) Pub. Date: Feb. 4, 2010

(54) SERVER CASING

(75) Inventors: Jian-Feng Wu, Shanghai City (CN); Shou-Jen Yang, Taipei City (TW)

Correspondence Address: J C PATENTS, 4 VENTURE, SUITE 250, IRVINE, CA, 92618, US

(73) Assignee: Inventec Corporation, Taipei City (TW)

(21) Appl. No.: 12/325,813

(22) Filed: Dec. 1, 2008

(30) Foreign Application Priority Data
Jul. 31, 2008 (CN) 200810129606.X

(51) Int. Cl. G06F 1/16

(52) U.S. Cl. 361/679.33

(57) ABSTRACT

A sever casing is provided, which includes a bottom cover including a bottom plate and two side plates. The bottom plate has at least one first crease line formed thereon, and the first crease line extends across the bottom plate. The first crease line is substantially parallel to two opposite side edges of the bottom plate. The side plates are respectively connected to the side edges of the bottom plate and are integrally formed with the bottom plate.

### CROSS-REFERENCE TO RELATED APPLICATION

This application claims the priority benefit of P.R.C. patent application serial no. 200810129606.x, filed on Jul. 31, 2008. The entirety of the above-mentioned patent application is hereby incorporated by reference herein and made a part of specification.

### BACKGROUND OF THE INVENTION

1. Field of the Invention

The present invention generally relates to a server, in particular, to a server casing.

2. Description of Related Art

Currently, with the rapid increase in demand for and creation of information in enterprises, a server that can integrate a variety of data processing functions to provide a large amount of information processing required by enterprises has been developed. A server with particular specifications is assembled to a purpose-made rack to provide flexibility for operational resource allocation. A server generally includes a casing and a plurality of functional modules mounted therein. The casing of the server is suspended within the rack by a pair of guide rails respectively located on two sides of the rack. However, the bottom of the casing may sag due to an excessively heavy load.

### SUMMARY OF THE INVENTION

Accordingly, the present invention is directed to a server casing for enhancing the structural strength of the bottom of the casing.

The present invention provides a server casing, which includes a bottom cover including a bottom plate and two side plates. The bottom plate has at least one first crease line formed thereon, and the first crease line extends across the bottom plate. The first crease line is substantially parallel to two opposite side edges of the bottom plate. The side plates are respectively connected to the side edges of the bottom plate and are integrally formed with the bottom plate.

In an embodiment of the present invention, the bottom plate has a hard disk accommodating area, and is further formed with a second crease line extending across the hard disk accommodating area and substantially parallel to the first crease line.

In an embodiment of the present invention, multiple first crease lines are provided, and the second crease line is located between the first crease lines.

In an embodiment of the present invention, the server casing further includes a hard disk cage mounted to the hard disk accommodating area and having a bottom wall. The bottom wall has a plurality of third crease lines respectively overlapping the first crease lines and the second crease line.

In an embodiment of the present invention, the bottom plate further has a plurality of ribs formed thereon.

In an embodiment of the present invention, at least one of the ribs extends in a direction substantially parallel to an extension direction of the side edges of the bottom plate.

In an embodiment of the present invention, at least one of the ribs extends in a direction substantially perpendicular to the extension direction of the side edges of the bottom plate.

In an embodiment of the present invention, at least two of the ribs intersect with each other.

In an embodiment of the present invention, the server casing further includes a reinforcing piece assembled to an inner face of the bottom plate. The reinforcing piece is in a shape substantially conforming to a shape of the corresponding rib.

In an embodiment of the present invention, the server casing further includes a reinforcing piece assembled to the inner face of the bottom plate and having at least one fourth crease line overlapping the first crease line.

In view of the above, in the above embodiments of the present invention, the crease lines formed on the bottom cover of the casing can enhance the structural strength of the bottom cover, thereby reducing the degree of sagging of the casing bottom when bearing a load.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view of a server casing according to an embodiment of the present invention.

FIG. 2 is a front view of a hard disk cage of FIG. 1 assembled to a bottom cover.

FIG. 3 is an exploded view of a server casing according to another embodiment of the present invention.

FIG. 4 is a perspective view of reinforcing pieces of FIG. 3 assembled to a bottom cover.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

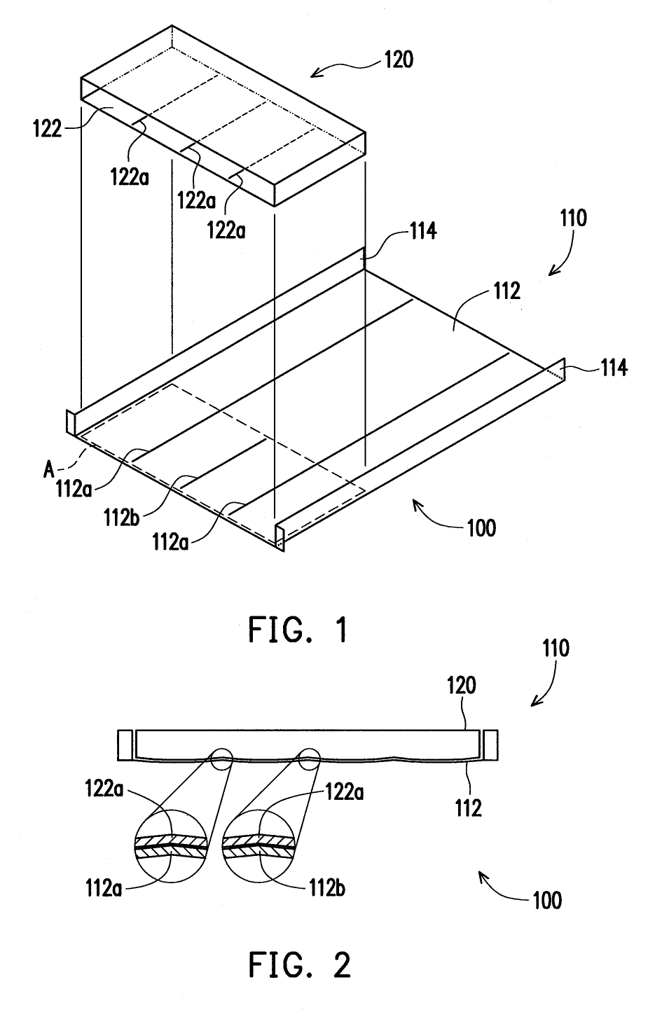

FIG. 1 is an exploded view of a server casing according to an embodiment of the present invention, and FIG. 2 is a front view of a hard disk cage of FIG. 1 assembled to a bottom cover. Referring to FIGS. 1 and 2, a server casing 100 of this embodiment includes a bottom cover 110. The bottom cover 110 includes a bottom plate 112 and two side plates 114. The side plates 114 are respectively connected to side edges of the bottom plate 112.

In order to enhance the structural strength of the bottom plate 112, the bottom plate 112 has a plurality of first crease lines 112a. The first crease lines 112a are formed on and extend across the bottom plate 112, substantially parallel to the two opposite side edges of the bottom plate 112, and projected toward the inside of the bottom cover 110. The first crease lines 112a help to reduce the degree of sagging of the bottom plate 112 when bearing a load.

In this embodiment, the bottom plate 112 has a hard disk accommodating area A. The number of the first crease lines 112a is two. The bottom plate 112 is further formed with a second crease line 112b extending across the hard disk accommodating area A. The second crease line 112b is located between and substantially parallel to the first crease lines 112a.

In this embodiment, the server casing 110 further includes a hard disk cage 120, which is mounted to the above hard disk accommodating area A for accommodating a hard disk (not shown). The hard disk cage 120 has a bottom wall 122. The bottom wall 122 has a plurality of third crease lines 122a respectively overlapping the first crease lines 112a and the second crease line 112b. Likewise, the third crease lines 122a also help to reduce the degree of sagging of the bottom wall 122 when bearing a load.

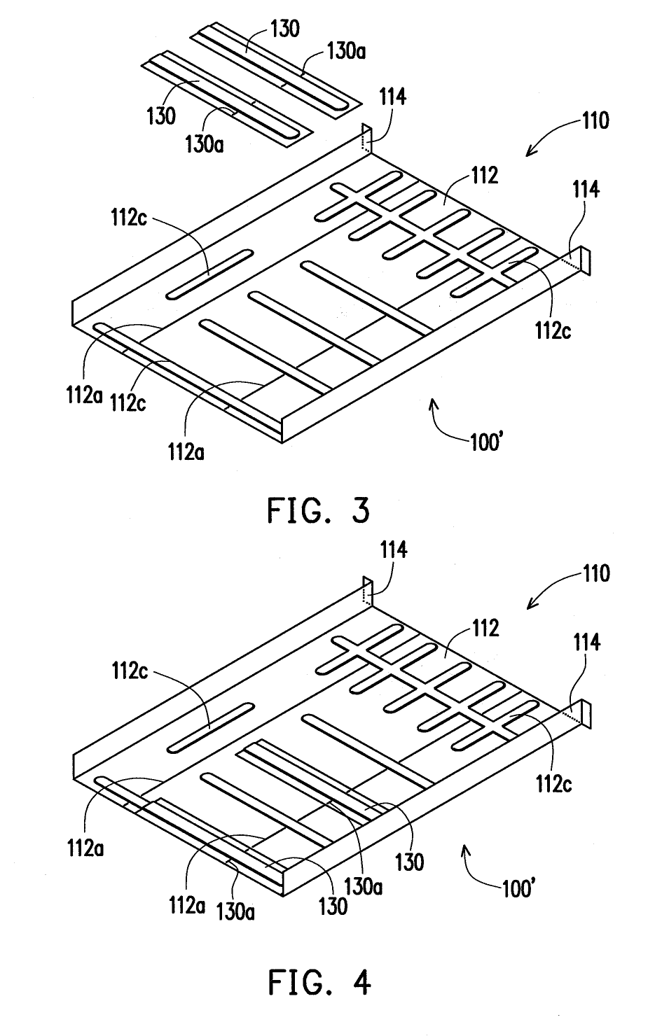

FIG. 3 is an exploded view of a server casing according to another embodiment of the present invention, and FIG. 4 is a perspective view of reinforcing pieces of FIG. 3 assembled to a bottom cover. Referring to FIGS. 3 and 4, a server casing 100′ of this embodiment also includes a bottom cover 110, as compared with the embodiment of FIG. 1. The bottom cover 110 includes a bottom plate 112 and two side plates 114. The side plates 114 are respectively connected to side edges of the bottom plate 112.

Likewise, in order to enhance the structural strength of the bottom plate 112, the bottom plate 112 also has a plurality of first crease lines 112a. The first crease lines 112a are formed on and extend across the bottom plate 112, substantially parallel to the two opposite side edges of the bottom plate 112, and projected toward the inside of the bottom cover 110. The first crease lines 112a help to reduce the degree of sagging of the bottom plate 112 when bearing a load.

In this embodiment, the bottom plate 112 further has a plurality of ribs 112c formed thereon, and the first crease lines 112a do not extend on the ribs 112c. Some of the ribs 112c may extend in a direction substantially parallel to an extension direction of the side edges of the bottom plate 112, some of the ribs 112c may extend in a direction substantially perpendicular to the extension direction of the side edges of the bottom plate 112, and some of the ribs 112c may intersect with each other.

In this embodiment, the server casing 100′ may further include one or more reinforcing pieces 130. The reinforcing pieces 130 may be assembled to an inner face of the bottom plate 112 in a riveting manner. Shapes of the reinforcing pieces 130 may substantially conform to shapes of the corresponding ribs 112c, so as to additionally enhance the structural strength of the bottom plate 112. Moreover, the reinforcing pieces 130 may also have at least one fourth crease line 130a overlapping the first crease line 112a. In other words, each of the reinforcing pieces 130 conforms to the shape of the corresponding first crease line by the fourth crease line 130a thereof.

To sum up, in the above embodiments of the present invention, the crease lines formed on the bottom cover of the casing can enhance the structural strength of the bottom cover, thereby reducing the degree of sagging of the bottom of the casing when bearing a load. Moreover, the structural strength of the bottom cover can be further enhanced by disposing additional ribs and reinforcing pieces, which can also reduce the degree of sagging of the bottom of the casing when bearing a load.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sever casing, comprising:
a bottom cover, comprising a bottom plate and two side plates, wherein the bottom plate comprises at least one first crease line formed thereon, the first crease line extends across the bottom plate and is substantially parallel to two opposite side edges of the bottom plate, and the side plates are respectively connected to the side edges of the bottom plate.

2. The sever casing according to claim 1, wherein the bottom plate comprises a hard disk accommodating area, and is further formed with a second crease line extending across the hard disk accommodating area and substantially parallel to the first crease line.

3. The sever casing according to claim 2, wherein multiple first crease lines are provided, and the second crease line is located between the first crease lines.

4. The sever casing according to claim 3, further comprising:
a hard disk cage, mounted to the hard disk accommodating area and comprising a bottom wall, wherein the bottom wall comprises a plurality of third crease lines respectively overlapping the first crease lines and the second crease line.

5. The sever casing according to claim 1, wherein the bottom plate further comprises a plurality of ribs formed thereon.

6. The sever casing according to claim 5, wherein at least one of the ribs extends in a direction substantially parallel to an extension direction of the side edges of the bottom plate.

7. The sever casing according to claim 5, wherein at least one of the ribs extends in a direction substantially perpendicular to the extension direction of the side edges of the bottom plate.

8. The sever casing according to claim 5, wherein at least two of the ribs intersect with each other.

9. The sever casing according to claim 5, further comprising:
a reinforcing piece, assembled to an inner face of the bottom plate, wherein the reinforcing piece is in a shape substantially conforming to a shape of the corresponding rib.

10. The sever casing according to claim 1, further comprising:
a reinforcing piece, assembled to the inner face of the bottom plate and comprising at least one fourth crease line overlapping the first crease line.
